(19) United States
(12) Patent Application Publication
(10) Pub. No.: US 2015/0155659 A1
(43) Pub. Date: Jun. 4, 2015

(54) ELECTRICAL CONNECTOR WITH REINFORCED ANTI-MISMATING MEMBER

(71) Applicant: ALLTOP ELECTRONICS (SUZHOU) LTD., Taicang City (CN)

(72) Inventors: Wang-I YU, JHONGHE City (TW); Hung-Chi TAI, JHONGHE City (TW); Ya-Juan GOU, JHONGHE City (TW); Dan LI, JHONGHE City (TW); Bai-Hu YANG, JHONGHE City (TW)

(73) Assignee: ALLTOP ELECTRONICS (SUZHOU) LTD., Taicang City (CN)

(21) Appl. No.: 14/212,270

(22) Filed: Mar. 14, 2014

(30) Foreign Application Priority Data
Dec. 2, 2013 (CN) 201310630752.1

(51) Int. Cl. H01R 13/642; H01R 24/60

(52) U.S. Cl. CPC H01R 13/642; H01R 24/60; H01R 2107/00

(57) ABSTRACT

An electrical connector includes an insulative housing, a number of contacts retained in the insulative housing, a shell enclosing the insulative housing and a reinforced anti-mismating member. The shell includes a number of peripheral walls having a top wall, a bottom wall and a pair of side walls connecting the top wall and the bottom wall. A receiving space is cooperatively formed by the top wall, the bottom wall and the pair of side walls. The reinforced anti-mismating member includes a base attached to one of the peripheral walls for strength improvement and a pair of rigid protrusions extending from the base. The pair of rigid protrusions further extend into the receiving space for preventing unmatched connectors from being inserted into the receiving space.

### BACKGROUND OF THE INVENTION

1. Field of the Invention

The present invention relates to an electrical connector, and more particularly to an electrical connector for being mounted to a circuit board.

2. Description of Related Art

FIG. 1 shows a conventional electrical connector 1 which includes an insulative housing 2, a plurality of contacts fixed to the insulative housing 2 and a shell 3 enclosing the insulative housing 2. The shell 3 includes a flat top wall 4, a pair of side walls 5 bent downwardly from the top wall 4 and a bottom wall 7 opposite to the top wall 4. The bottom wall 7 includes a pair of half portions 6 jointed together. The top wall 4 includes a pair of slits 8 and a pair of protrusions 9 adjacent to the slits 8 to function as an anti-mismating member. However, since there are slits 8, the bearing strength of the top wall 4 may be decreased. Besides, since the height of the protrusions 9 along the vertical direction is corresponding to the slits 8, on one hand, if the slits 8 are wide enough to get the protrusions 9 with reasonable height, the bearing strength of the top wall 4 may be weak; and on the other hand, if the slits 8 are narrow, it is difficult to achieve the protrusions with reasonable height.

Hence, it is desirable to provide an electrical connector with reinforced anti-mismating member.

### BRIEF SUMMARY OF THE INVENTION

The present invention provides an electrical connector including an insulative housing, a plurality of contacts fixed to the insulative housing, a shell enclosing the insulative housing and a reinforced anti-mismating member. The insulative housing includes a base portion and a mating portion extending forwardly from the base portion along a rear-to-front direction. The shell includes a plurality of peripheral walls comprising a top wall, a bottom wall and a pair of side walls connecting the top wall and the bottom wall. A receiving space is cooperatively formed by the top wall, the bottom wall and the pair of side walls. The mating portion cantileveredly extends forwardly into the receiving space. The reinforced anti-mismating member includes a base attached to one of the peripheral walls and a pair of rigid protrusions extending from the base. The pair of rigid protrusions extend into the receiving space for preventing unmatched connectors from being inserted into the receiving space. With the reinforced anti-mismating member fixed to the shell, the integral strength of the electrical connector can be improved.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The components in the drawing are not necessarily drawn to scale, the emphasis instead being placed upon clearly illustrating the principles of the described embodiments. In the drawings, reference numerals designate corresponding parts throughout various views, and all the views are schematic.

FIG. 1 is a perspective view of a conventional electrical connector;

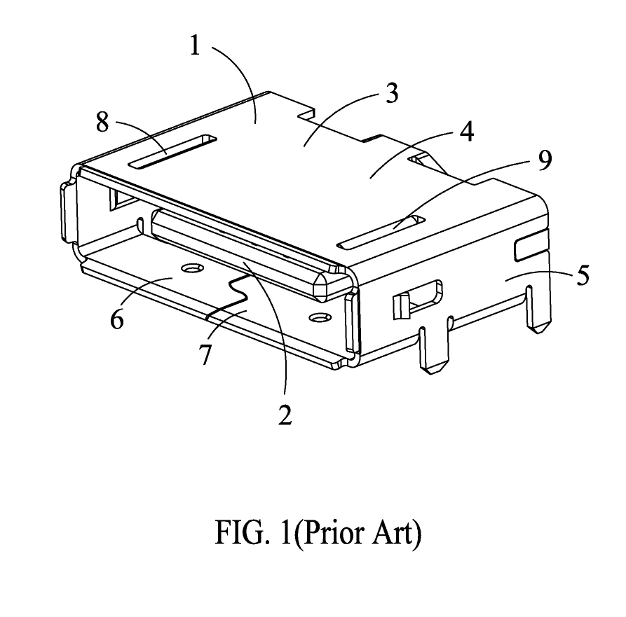

FIG. 2 is a perspective view of an electrical connector in accordance with an illustrated embodiment of the present invention;

FIG. 3 is another perspective view of the electrical connector shown in FIG. 2, while taken from a different aspect;

FIG. 4 is an exploded view of the electrical connector shown in FIG. 2;

FIG. 5 is another exploded view of the electrical connector shown in FIG. 2;

FIG. 6 is a perspective view of an insulative housing and contacts of the electrical connector shown in FIG. 4; and

FIG. 7 is a perspective view of a metallic shell of the electrical connector shown in FIG. 2.

### DETAILED DESCRIPTION OF THE PREFERRED EMBODIMENT

Reference will now be made to the drawing figures to describe the embodiments of the present invention in detail. In the following description, the same drawing reference numerals are used for the same elements in different drawings.

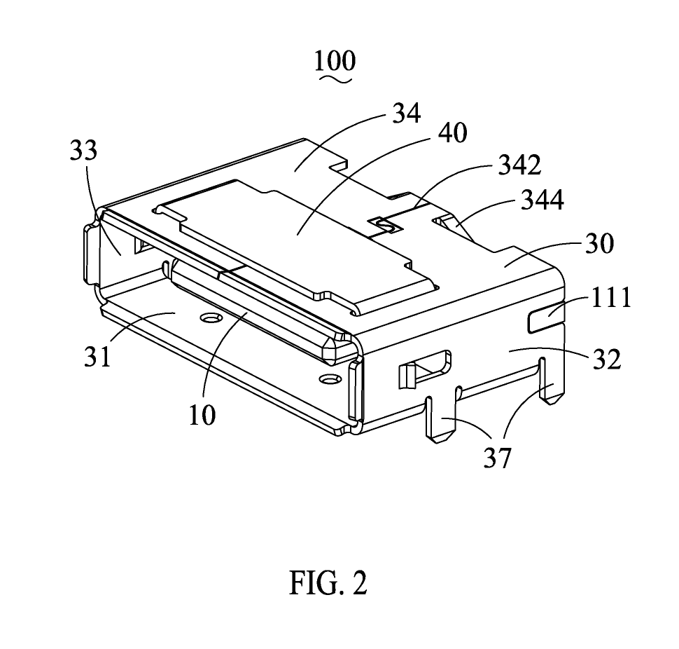

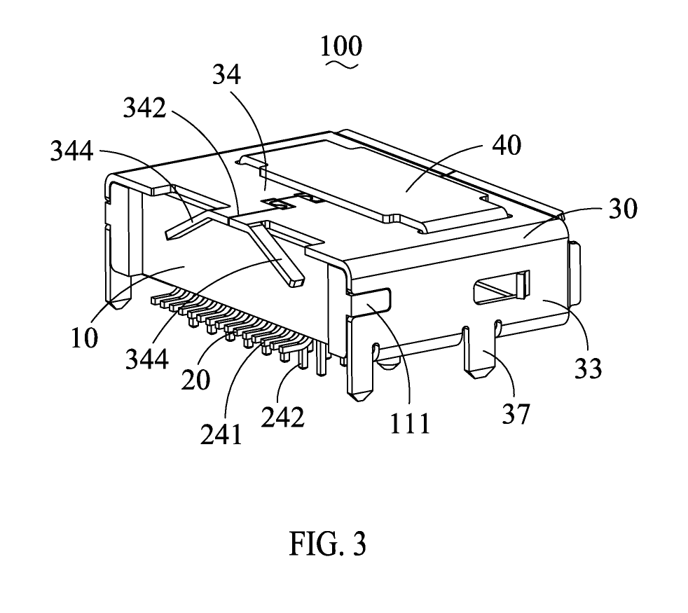

Referring to FIGS. 2 to 4, the present invention discloses an electrical connector 100 for being mounted on a circuit board (not shown) for receiving a complementary plug connector (not shown). The electrical connector 100 includes an insulative housing 10, a plurality of contacts 20 fixed to the insulative housing 10, a metallic shell 30 enclosing the insulative housing 10 and a reinforced anti-mismating member 40 attached to one peripheral wall of the shell 30.

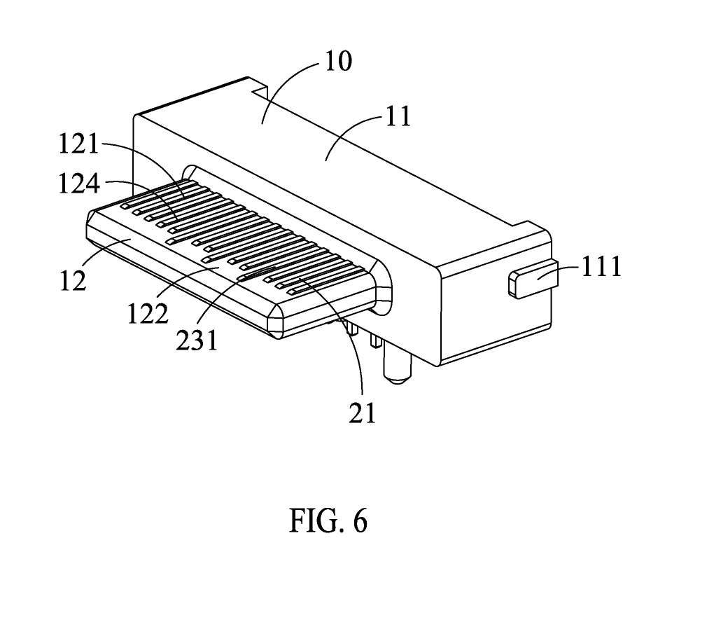

Referring to FIGS. 2 to 6, the insulative housing 10 includes a base portion 11 and a mating portion 12 extending forwardly from the base portion 11 along a rear-to-front direction. The base portion 11 is of a rectangular configuration and includes a pair of positioning blocks 111 on lateral sides thereof. The mating portion 12 includes an upper surface 122, a lower surface 123 opposite to the upper surface 122, and a plurality of contact-receiving passageways 121 extending through the upper surface 122 and the lower surface 123. In detail, the passageways 121 includes a plurality of first/upper passageways 124 extending upwardly through the upper surface 122 and a plurality of second/lower passageways 125 extending downwardly through the lower surface 123.

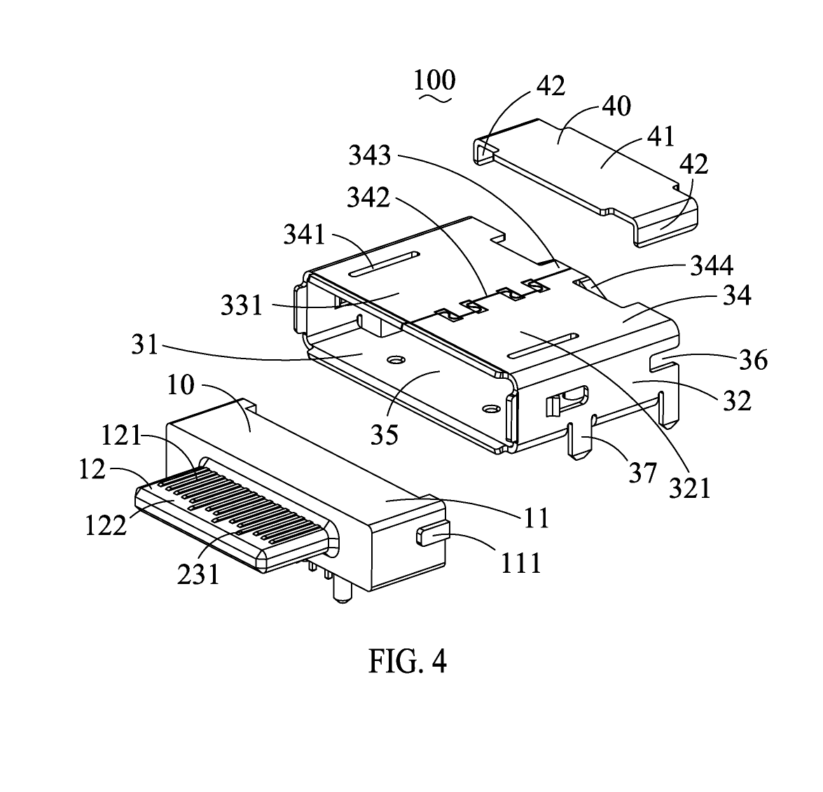

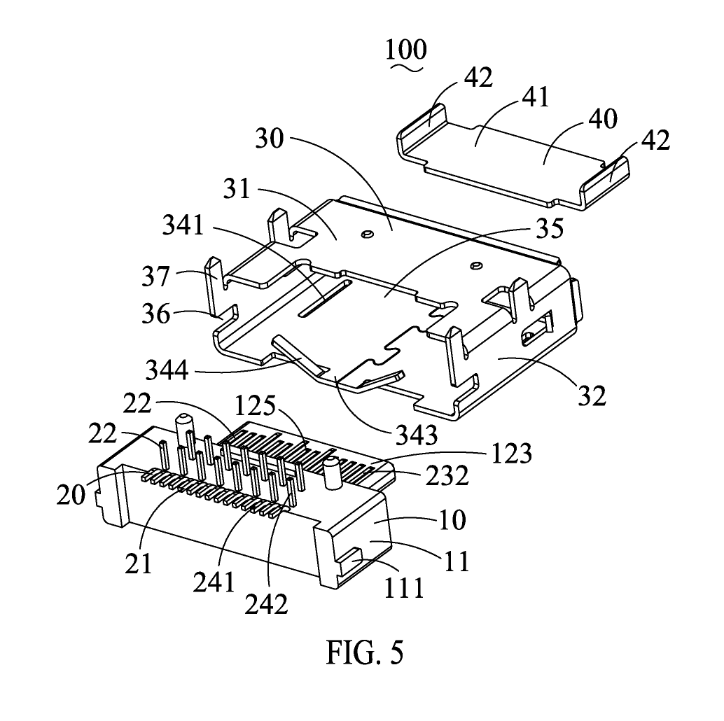

Referring to FIGS. 4 and 5, the contacts 20 include a plurality of first/upper contacts 21 received in the first passageways 124 and a plurality of second/lower contacts 22 received in the second passageways 125. Each first contact 21 includes a flat first contacting section 231 received in the first passageways 124 and a first soldering section 241 parallel to the first contacting section 231. Each second contact 22 includes a flat second contacting section 232 received in the second passageways 125 and a second soldering section 242 parallel to the second contacting section 232. The first and the second contacting sections 231, 232 are exposed on the upper and lower surfaces 122, 123 of the mating portion 12, respectively. As shown in FIG. 5, the first soldering sections 241 are arranged in a single row. The second soldering sections 242 are arranged in two rows. The first soldering sections 241 are located outside of the second soldering sections 242. According to the illustrated embodiment of the present invention, the first soldering sections 241 are mounted to the circuit board via SMT technology, and the second soldering sections 242 are mounted to the circuit board via Through Hole technology.

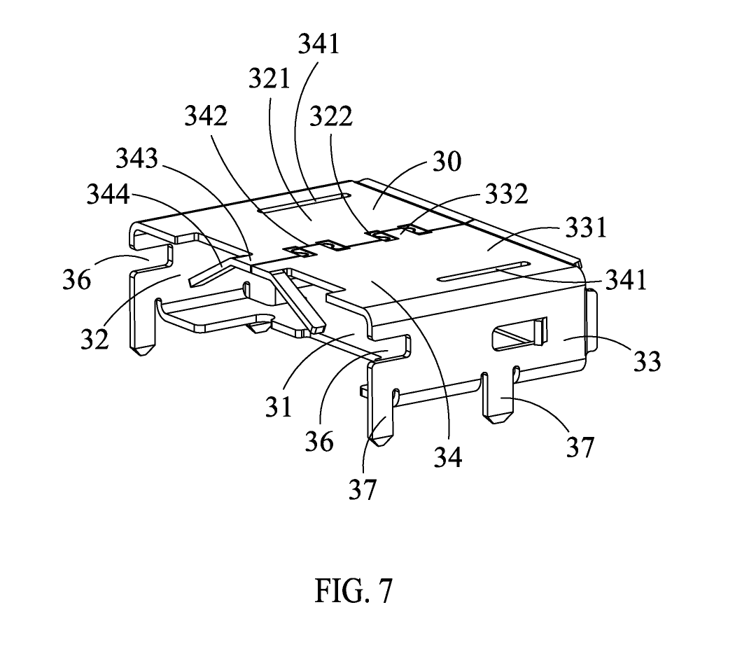

Referring to FIGS. 4, 5 and 7, the shell 30 includes a plurality of peripheral walls enclosing the insulative housing 10. The peripheral walls include a top wall 34, a bottom wall 31 and a pair of first and second side walls 32, 33 connecting the top wall 34 and the bottom wall 31. According to the illustrated embodiment of the present invention, the shell 30 is stamped and bent from a single metallic sheet for easily manufacturing. The top wall 34 includes a first half portion 321 and a second half portion 331 combined together along a joint 342. The first half portion 321 is bent from the first side wall 32 and the second half portion 331 is bent from the second side wall 33. A receiving space 35 is cooperatively formed by the top wall 34, the bottom wall 31 and the pair of first and second side walls 32, 33. The mating portion 12 cantileveredly extends forwardly into the receiving space 35 for mating with the complementary plug connector. Each of the first half portion 321 and the second half portion 331 defines a slit 341. The two slits 341 are located at opposite sides of the joint 342 and are symmetrical with each other. The first half portion 321 includes a dovetail-shaped slot 322 and the second half portion includes a dovetail-shaped protrusion 332 engaging with the dovetail-shaped slot 322 for fixation. Besides, the top wall 34 includes a rear protrusion 343. Each of the first half portion 321 and the second half portion 331 is stamped to form a slant tab 344 at a rear edge thereof. The slant tabs 344 engage with a rear end of the base portion 11 for position restriction. Furthermore, the first and second side walls 32, 33 include a pair of positioning cutouts 36 to engage with the positioning blocks 111, respectively. Each of the first and second side walls 32, 33 includes a pair of soldering legs 37 extending downwardly for being soldered to the circuit board.

Referring to FIGS. 4 and 5, the reinforced anti-mismating member 40 is metallic and is of a reversed U-shaped configuration. The reinforced anti-mismating member 40 includes a base 41 and a pair of rigid protrusions 42 bent downwardly from lateral sides of the base 41. According to the illustrated embodiment of the present invention, the base 41 is attached to the top wall 34 via spot welding. The pair of rigid protrusions 42 are parallel to each other and each rigid protrusion 42 is positioned along a vertical plane. The pair of rigid protrusions 42 extend through the slits 341 and into the receiving space 35 for preventing unmatched connectors from being inserted into the receiving space 35. It is understandable to those of ordinary skill in the art that the word “rigid” means the protrusions 42 are essentially hard for positioning while a small reasonable deformation thereof if permitted. The base 41 straddles the joint 342 of the first half portion 321 and the second half portion 331 so that the joint 342 can be prevented from splitting. As shown in FIG. 2, a dimension of the base 41 along the rear-to-front direction is smaller than that of the joint 342 along the rear-to-front direction for material saving.

With the reinforced anti-mismating member 40 fixed to the top wall 34 of the shell 30, even if there are two slits 341 formed on the top wall 34, the integral strength of the electrical connector 100 can be improved. Besides, since the anti-mismating member 40 and the shell 30 are two independent members in manufacturing, the depth of the rigid protrusions 42 extending into the receiving space 35 is nothing to do with the dimension of the slits 341.

It is to be understood, however, that even though numerous characteristics and advantages of preferred and exemplary embodiments have been set out in the foregoing description, together with details of the structures and functions of the embodiments, the disclosure is illustrative only; and that changes may be made in detail within the principles of present disclosure to the full extent indicated by the broadest general meaning of the terms in which the appended claims are expressed.

What is claimed is:

1. An electrical connector comprising:
an insulative housing comprising a base portion and a mating portion extending forwardly from the base portion along a rear-to-front direction;
a plurality of contacts fixed to the insulative housing;
a shell comprising a plurality of peripheral walls enclosing the insulative housing, the peripheral walls comprising a top wall, a bottom wall and a pair of side walls connecting the top wall and the bottom wall, a receiving space being cooperatively formed by the top wall, the bottom wall and the pair of side walls, the mating portion cantileveredly extending forwardly into the receiving space; and
a reinforced anti-mismating member comprising a base attached to one of the peripheral walls and a pair of rigid protrusions extending from the base; wherein
the pair of rigid protrusions extend into the receiving space for preventing unmatched connectors from being inserted into the receiving space.

2. The electrical connector as claimed in claim 1, wherein the reinforced anti-mismating member is metallic and is of a reversed U-shaped configuration.

3. The electrical connector as claimed in claim 1, wherein the base is attached to a top side of the top wall, and the top wall defines a pair of slits through which the pair of rigid protrusions extend.

4. The electrical connector as claimed in claim 3, wherein the top wall comprises a first half portion and a second half portion combined together, the pair of slits being respectively formed on the first half portion and the second half portion, the base straddling a joint of the first half portion and the second half portion.

5. The electrical connector as claimed in claim 4, wherein a dimension of the base along the rear-to-front direction is smaller than that of the joint along the rear-to-front direction.

6. The electrical connector as claimed in claim 4, wherein the first half portion comprises a dovetail-shaped slot and the second half portion comprises a dovetail-shaped protrusion engaging with the dovetail-shaped slot.

7. The electrical connector as claimed in claim 1, wherein the pair of rigid protrusions are parallel to each other.

8. The electrical connector as claimed in claim 7, wherein each rigid protrusion is positioned along a vertical plane.

9. The electrical connector as claimed in claim 1, wherein the mating portion comprises an upper surface and a lower surface opposite to the upper surface, the contacts comprising a plurality of first contacts each of which comprises a flat first contacting section exposed on the upper surface and a plurality of second contacts each of which comprises a flat second contacting section exposed on the lower surface.

10. The electrical connector as claimed in claim 9, wherein each first contact comprises a horizontal soldering section parallel to the first contacting section, each second contact comprises a vertical soldering section perpendicular to the second contacting section, and the horizontal soldering sections are located outside of the vertical soldering sections.

11. The electrical connector as claimed in claim 10, wherein the horizontal soldering sections are arranged in a single row and the vertical soldering sections are arranged in two rows.

12. The electrical connector as claimed in claim 4, wherein each of the first half portion and the second half portion is stamped to form a slant tab at a rear edge thereof, and the slant tabs engage with a rear end of the base portion for position restriction.

13. The electrical connector as claimed in claim 1, wherein the base portion comprises a pair of positioning blocks on lateral sides thereof, and the side walls of the shell define a pair of positioning cutouts to engage with the positioning blocks, respectively.

14. An electrical connector comprising:
an insulative housing comprising a base portion and a mating portion extending forwardly from the base portion along a rear-to-front direction;
a plurality of contacts fixed to the insulative housing, the contacts comprising a plurality of first contacts and a plurality of second contacts, each first contact comprising a flat first contacting section exposed on an upper surface of the mating portion and a horizontal soldering section parallel to the first contacting section, each second contact comprising a flat second contacting section exposed on a lower surface of the mating portion and a vertical soldering section perpendicular to the horizontal soldering section;
a metallic shell comprising a plurality of peripheral walls enclosing the insulative housing, the peripheral walls comprising a top wall, a bottom wall and a pair of side walls connecting the top wall and the bottom wall, a receiving space being jointly formed by the top wall, the bottom wall and the pair of side walls, the mating portion extending into the receiving space; and
a reinforced anti-mismating member comprising a pair of rigid protrusions extending into the receiving space for preventing unmatched connectors from being inserted into the receiving space.

15. The electrical connector as claimed in claim 14, wherein the pair of rigid protrusions are parallel to each other and each of which is positioned in a vertical plane.

16. The electrical connector as claimed in claim 14, wherein the reinforced anti-mismating member is of a reversed U-shaped configuration and comprises a base attached to a top side of the top wall, the pair of rigid protrusions bent downwardly from lateral edges of the base.

17. The electrical connector as claimed in claim 16, wherein the top wall comprises a first half portion and a second half portion combined together, the first half portion and the second half portion defining a pair of slits through which the pair of rigid protrusions extend.

18. The electrical connector as claimed in claim 17, wherein the first half portion comprises a dovetail-shaped slot and the second half portion comprises a dovetail-shaped protrusion engaging with the dovetail-shaped slot, the base straddling a joint of the first half portion and the second half portion.

19. The electrical connector as claimed in claim 18, wherein a dimension of the base along the rear-to-front direction is smaller than that of the joint along the rear-to-front direction.

20. The electrical connector as claimed in claim 14, wherein the reinforced anti-mismating member is made of a metallic material and is fixed to the metallic shell via spot welding.
